(19) United States
(12) Patent Application Publication
(10) Pub. No.: US 2002/0015488 A1
(43) Pub. Date: Feb. 7, 2002

(54) Method of echo cancellation and equipment of echo cancellation

(75) Inventor: Hidetoshi Fuse, Tokyo (JP)

Correspondence Address: Connolly Bove Lodge & Hutz LLP, Suite 800, 1990 M Street, N.W., Washington, DC, 20036-3425, US

(73) Assignee: Matsushita Electric Industrial Co., Ltd., Osaka (JP)

(21) Appl. No.: 09/918,486

(22) Filed: Aug. 1, 2001

(30) Foreign Application Priority Data
Aug. 3, 2000 (JP) 2000-235570

(51) Int. Cl. H04M 9/08

(52) U.S. Cl. 379/406.01

(57) ABSTRACT

Echo cancellation equipment comprises an echo canceller to cancel a leaked voice signal on a transmitting line, which is leaked in part from a receiving line to the transmitting line. Additionally, the equipment comprises input level adjusting means for limiting, to a level falling in a predetermined range, a level of a transmitting voice signal to be inputted into the echo canceller and output level adjusting means for restoring the level of the transmitting voice signal outputted from the echo canceller, to the previous level of the signal which is present before being limited by the input level adjusting means. This level adjustment enables echoes to be canceled without failure at any time, even if the voice signal level on a transmitting line changes due to differences in design of levels for a network, characteristics of a hybrid circuit that might cause an echo, or others.

### BACKGROUND OF THE INVENTION

1. (Field of the Invention)

The present invention relates to a method for canceling an echo and equipment for canceling the same, and in particular, to the method and equipment for canceling a leaked voice signal caused when a receiving voice signal leaking in part into a transmitting voice signal in communication systems such as a telephone communication system.

2. (Description of Related Art)

In voice networks such a telephone communication system, if a receiving signal is partly leaked into a transmitting signal, the leaked signal causes an echo. The echo is attributable to, for example, a hybrid circuit used for conversion between a four-wire circuit and a two-wire circuit and an acoustic feedback occurring at an end user's terminal. In networks, the echo combined with a delay in communication deteriorates acoustic quality. Thus, in general, voice transmission systems, in which a voice signal is set up into an ATM (Asynchronous Transfer Mode) cell or IP (Internet Protocol) packet, has an echo cancellation equipment to avoid voice quality from being deteriorated.

This kind of conventional echo cancellation equipment is disclosed by, for example, Japanese Patent Laid-open publication No. 8-130497. In this echo cancellation system, it is determined whether the network is in a single talk state or in a double talk state. The single talk state shows that a voice signal is transmitted through only a receiving line, while the double talk state shows that voice signals are transmitted through both transmitting line and receiving line. According to the echo cancellation equipment disclosed by the publication, characters of an echo-routed path are determined only during the single talk state.

In the case of the foregoing echo cancellation equipment, a plurality of parameters are used to distinguish the single talk state from the double talk state. However, some parameters depend on the absolute level of a transmitting input voice signal passing through the echo cancellation equipment. Depending on design of levels in a network and characteristics of a hybrid circuit that might cause an echo, the network tends to be determined into either the double talk state or the single talk state in an erroneous manner.

### SUMMARY OF THE INVENTION

The present invention has been made to overcome the above difficulty, and an object of the present invention is to provide an echo cancellation method and echo cancellation equipment capable of properly canceling an echo at any time, even when a voice signal sending through a transmitting line changes in its signal level due to design of signal levels in a network and characteristics of a hybrid circuit.

According to one aspect of the present invention, there is provided a method for canceling an echo caused by a voice signal leaking in part from a voice signal passing through a receiving line into a transmitting line, the method comprising the steps of: limiting a level of the voice signal passing through the transmitting line to a level falling in a predetermined range before the leaked voice signal is cancelled; canceling the leaked voice signal included in the voice signal passing through the transmitting line; and restoring, to an original level of the voice signal obtained before the cancellation of the leaked voice signal, a level of a voice signal undergoing the cancellation of the leaked voice signal and passing through the transmitting line. Accordingly, the voice signal level on the transmitting line changes due to various factors, such as design of levels for a network or characteristics of a hybrid circuit that might cause an echo, it is possible to have the echo cancellation performed within an appropriate range of voice signal levels. Therefore, the echo cancellation is always done in a proper way.

It is preferred that the above method further comprises the steps of: determining whether or not either one of facsimile communication and communication on modems through the transmitting line is detected; and if either one of facsimile communication and communication on modems is detected, stopping the cancellation of the leaked voice signal, the limitation of the level of the voice signal, and the restoration of the level of the voice signal. As a result, influences of the level adjustment on facsimile communication or communication on modems can be avoided.

According to a further aspect of the present invention, there is provided an echo cancellation equipment having an echo canceller canceling an echo caused by a voice signal leaking in part from a voice signal passing through a receiving line into a transmitting line, comprising: echo-canceller input level adjusting means for limiting, to a value falling in a predetermined range, a level of the voice signal passing through the transmitting line to the echo canceller; and echo-canceller output level adjusting means for restoring, to an original level of the voice signal limited by the echo-canceller input level adjusting means, a level of a voice signal outputted from the echo canceller. Accordingly, the voice signal level on the transmitting line changes due to various factors, such as design of levels for a network or characteristics of a hybrid circuit that might cause an echo, it is possible to make the echo cancellation operate within an appropriate range of voice signal levels. Therefore, the echo cancellation is always done in a proper way.

Preferably, the above echo cancellation equipment further comprises determining means for determining whether or not either one of facsimile communication and communication on modems through the transmitting line is detected; and stopping means for stopping, if the determining means determines that either one of facsimile communication and communication on modems is detected, a canceling operation of the echo canceller, a level limiting operation of the echo-canceller input level adjusting mans, and a level restoring operation of the echo-canceller output level adjusting means. As a result, influences of the level adjustment on facsimile communication or communication on modems can be avoided.

### BRIEF DESCRIPTION OF THE DRAWING

In the accompanying drawing:

FIG. 1 is a block diagram showing the configuration of an embodiment of echo cancellation equipment according to the present invention.

### DETAILED DESCRIPTION OF THE PREFERRED EMBODIMENT

An embodiment according to the present invention will now be described in detail with reference to the accompanying drawing.

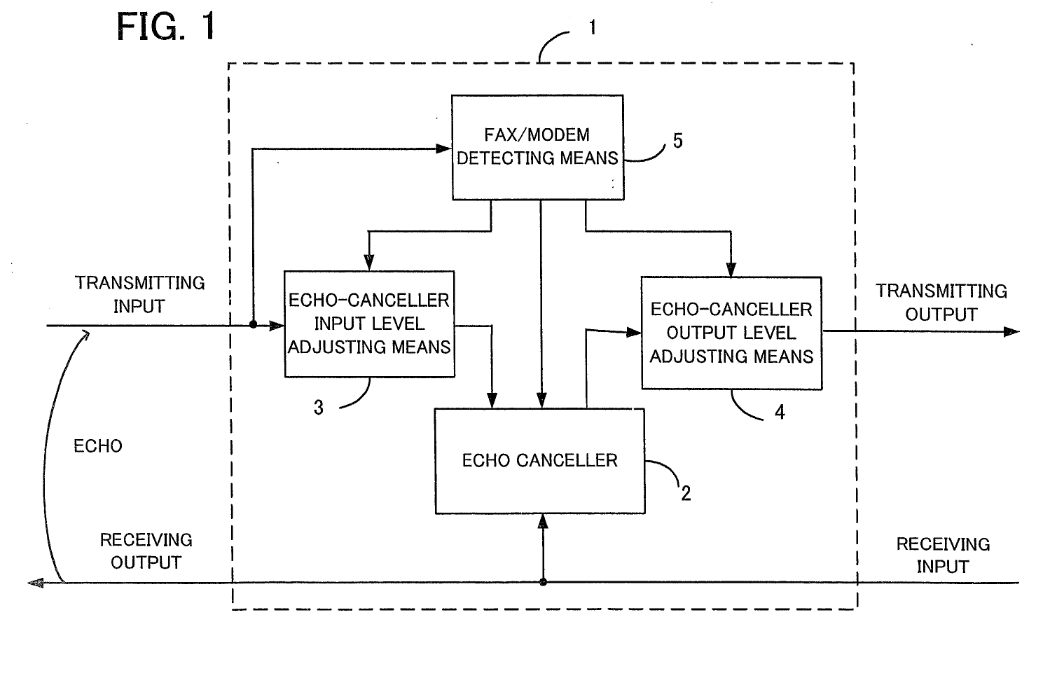

FIG. 1 is a block diagram showing the configuration of an embodiment of echo cancellation equipment according to the present invention.

As shown therein, the echo cancellation equipment 1 is connected to both of a transmitting line and a receiving line so as to form a four-terminal network. In the echo cancellation equipment 1, input and output terminals of a voice signal in the receiving line are connected to each other, and this receiving voice line is connected to an input terminal of an echo canceller 2, in which a receiving voice signal is inputted into the echo canceller 2 through the input terminal.

A transmitting-voice-signal input terminal of the echo canceller 2 is coupled to a transmitting-voice-signal input terminal of the echo cancellation equipment 1 via an echo-canceller input level adjusting means 3. A transmitting-voice-signal output terminal of the echo canceller 2 is coupled to a transmitting-voice-signal output terminal of the echo cancellation equipment 1 via an echo-canceller output level adjusting means 4.

A facsimile (FAX)/modem detecting means 5 is electrically connected to the transmitting-voice-signal input terminal of the echo cancellation equipment 1. Output terminals of the detecting means 5 are connected to a control input terminal of each of the echo canceller 2, echo-canceller input level adjusting means 3, and echo-canceller output level adjusting means 4.

The echo canceller 2 is configured so that an echo, which is a receiving output voice signal combined into a transmitting input voice signal, is cancelled by using the receiving output voice signal.

The echo-canceller input level adjusting means 3 is configured so as to adjust in the level a transmitting input voice signal transmitted to this echo cancellation equipment 1. According to a network employing the echo cancellation equipment 1, a constant amount of level adjustment is previously set to the echo-canceller input level adjusting means 3. The level adjustment amount is properly determined beforehand. Specifically, in a previous inspection carried out for applying the echo cancellation equipment 1 to a certain network, an amount of level adjustment to allow the echo canceller 2 to operate well is obtained through tests. This level adjustment amount is then set as a fixed value.

The echo-canceller output level adjusting means 4 has a configuration that is able to adjust the level of a transmitting output voice signal that has underwent the echo cancellation, then output its adjusted signal on the transmitting line. Like the above, a constant amount of level adjustment is previously set to the echo-canceller output level adjusting means 4. The level adjustment amount is also properly determined beforehand.

The amounts of level adjustment used by both echo-canceller input level adjusting means 3 and echo-canceller output level adjusting means 4 could be specified independently of each other. However, for designing a level diagram for a network, it is normal that levels at the echo canceller are kept unchanged, and instead, levels are adjusted at other network devices.

The present embodiment also employs the above general technique. In other words, the amounts of level adjustment are specified so that a reduced level by the echo-canceller input level adjusting means 3 is raised up to its original input level by the echo-canceller output level adjusting means 4. This keeps the same level between the transmitting input voice signal and the transmitting output voice signal, while the level of only the transmitting input voice signal to the echo canceller 2 can be adjusted. This way of level adjustment eliminates the necessity of re-adjusting a level diagram already set to other network devices, even in the case that the echo cancellation equipment 1 is additionally installed into existing networks, thus raising the versatility of the echo cancellation equipment 1.

The FAX/modem detecting means 5 detects, from the transmitting input voice signal, a signal involved with facsimile communication or communication on modems has a configuration of controlling the echo canceller 2, echo-canceller input level adjusting means 3, and echo-canceller output level adjusting means 4.

The entire operation of the thus-configured echo cancellation equipment will now be described.

Due to a hybrid circuit used for conversion between a four-wire circuit and a two-wire circuit, an acoustic feedback at an end user's terminal, or other factors, the receiving output voice signal from the echo cancellation equipment 1 leaks in part into the transmitting input voice signal, thus causing an echo. This echo is supplied to the echo canceller 2. The echo canceller 2 estimates an impulse response to a route of the echo from both of the receiving output voice signal and transmitting input voice signal, convolutes both of the receiving output voice signal and the impulse response to produce a pseudo echo, and subtracts the pseudo echo from the transmitting input voice signal. Thus, the echo is canceled from the transmitting input voice signal.

For estimating the impulse response of the route of the echo, the echo canceller 2 cannot estimate the impulse response with precision under the double talk state, because disturbance signals are contained in the transmitting input voice signal under such double talk state. To avoid this inconvenience, the echo canceller 2 determines if the network is in the single talk state or double talk state on the basis of both of the receiving input voice signal and the transmitting input voice signal. And the echo canceller 2 estimates the impulse response of the route of the echo under only the single talk state, but the echo canceller 2 stops to estimate such impulse response under the double talk state.

Though a plurality of parameters are used for determining if a network is under the single talk state or the double talk state, some parameters depend on an absolute level of a transmitting input voice signal to the echo canceller 2. Depending on designed states of levels for a network, characteristics of a hybrid circuit that might be attributable to an echo, and/or others, there are some cases in which an absolute level of the transmitting input voice signal is relatively high. In such a case, there is a tendency that the network is determined to be under the double talk state, even though the impulse response to the route of an echo could be estimated with precision. If determined to be under the double talk state in such a case, an amount of canceling an echo and a convergence time for cancellation of an echo are deteriorated in precision.

In such a case, according to the present embodiment, the transmitting input voice signal to the echo cancellation equipment 1 is reduced in the level down to a level falling in a predetermined range by the echo-canceller input level adjusting means 3, then sent to the echo canceller 2. As a result, the level of the transmitting input voice signal to the echo canceller 2 is given as a level falling in a range that allows the echo canceller 2 to determine the single talk state or the double talk state with accuracy.

Additionally, the echo-canceller output level adjusting means 4 raise the signal level by an amount reduced by the echo-canceller input level adjusting means 3. A combination of the adjusting means 3 and 4 makes it possible that the levels of the transmitting input voice signal and transmitting output voice signal to and from the echo cancellation equipment 1 are kept unchanged, but only the transmitting input voice signal to the echo canceller 2 is adjusted in the level.

On the other hand, the FAX/modem detecting means 5 monitors the transmitting input voice signal to the echo cancellation equipment 1. If detecting facsimile communication or communication on modems during the monitoring, the detecting means 5 makes the echo canceller 2 stop its operation, makes both echo-canceller input level adjusting means 3 and echo-canceller output level adjusting means 4 stop their level adjustment operations. This stop control permits the transmitting input voice signal to be outputted as a transmitting output voice signal without any processing performed on the signal. Thus influences of the level adjustment on the facsimile communication or communication with modems can be avoided.

The foregoing has been described about an embodiment in which the transmitting input voice signal inputted to the echo cancellation equipment 1 is relatively higher in the level, depending on various factors, such as design of levels for a network or characteristics of a hybrid circuit which might cause an echo. Alternatively, the echo cancellation technique can be applied to an embodiment in which the transmitting input voice signal inputted to the echo cancellation equipment is relatively lower in the level. In such a case, the transmitting input voice signal to the echo cancellation apparatus 1 is raised in the level by the echo-canceller input level adjusting means 3 up to a level residing within a certain range, then sent to the echo canceller 2. In contrast, the signal level is reduced by the echo-canceller output level adjusting means 4 by an amount of level increased by the echo-canceller input level adjusting means 3, so that the signal is kept to its original level.

As can be understood from the above, the voice signal level on the transmitting line changes due to various factors, such as design of levels for a network or characteristics of a hybrid circuit that might cause an echo, it is possible to make the echo canceller operate within an appropriate range of voice signal levels. Therefore, the echo cancellation equipment applied to various types of network is able to provide the advantage that a satisfactory characteristic of echo cancellation can be obtained.

The present invention is not limited to the above embodiment, and can be carried out in further various modes within the gist of the present invention indicated by the appended claims.

What is claimed is:

1. A method for canceling an echo caused by a voice signal leaking in part from a voice signal passing through a receiving line into a transmitting line, the method comprising the steps of:
limiting a level of the voice signal passing through the transmitting line to a level falling in a predetermined range before the leaked voice signal is cancelled;
canceling the leaked voice signal included in the voice signal passing through the transmitting line; and
restoring, to an original level of the voice signal obtained before the cancellation of the leaked voice signal, a level of a voice signal undergoing the cancellation of the leaked voice signal and passing through the transmitting line.

2. The method of claim 2, further comprising the steps of:
determining whether or not either one of facsimile communication and communication on modems through the transmitting line is detected; and
if either one of facsimile communication and communication on modems is detected, stopping the cancellation of the leaked voice signal, the limitation of the level of the voice signal, and the restoration of the level of the voice signal.

3. An echo cancellation equipment having an echo canceller canceling an echo caused by a voice signal leaking in part from a voice signal passing through a receiving line into a transmitting line, comprising:
echo-canceller input level adjusting means for limiting, to a value falling in a predetermined range, a level of the voice signal passing through the transmitting line to the echo canceller; and
echo-canceller output level adjusting means for restoring, to an original level of the voice signal limited by the echo-canceller input level adjusting means, a level of a voice signal outputted from the echo canceller.

4. The echo cancellation equipment of claim 3, further comprising
determining means for determining whether or not either one of facsimile communication and communication on modems through the transmitting line is detected; and
stopping means for stopping, if the determining means determines that either one of facsimile communication and communication on modems is detected, a canceling operation of the echo canceller, a level limiting operation of the echo-canceller input level adjusting mans, and a level restoring operation of the echo-canceller output level adjusting means.
